(19) United States
(12) Patent Application Publication
(10) Pub. No.: US 2026/0275094 A1
(43) Pub. Date: Sep. 17, 2026

(54) POLYMER COMPOSITION SUITABLE FOR FILM MANUFACTURING

(71) Applicant: BOREALIS AG, Vienna (AT)

(72) Inventors: Jingbo Wang, Linz (AT); Klaus Bernreitner, Linz (AT); Peter Niedersuess, Linz (AT); Stefan Ortner, Linz (AT); Joel Fawaz, Linz (AT); Karlheinz Friedrich, Schwechat-Mannswörth (AT)

(21) Appl. No.: 19/104,303

(22) PCT Filed: Aug. 17, 2023
(86) PCT No.: PCT/EP2023/072635

§ 371 Date: Feb. 17, 2025

(30) Foreign Application Priority Data
Aug. 24, 2022 (EP) 22191829.5

(51) Int. Cl. C08L 23/12; C08J 5/18

(52) U.S. Cl. CPC C08L 23/12; C08J 5/18; C08J 2323/12; C08J 2323/14; C08L 2205/025; C08L 2205/242; C08L 2207/02; C08L 2207/14; C08L 2314/06

(57) ABSTRACT

The present invention relates to a polymer composition suitable for manufacturing a film comprising the following components: a) 99.0 to 99.9999 wt.-% based on the total weight of the polymer composition of a metallocene-catalysed heterophasic polypropylene comprising: i) 80 to 95 wt.-% of a crystalline matrix being a propylene homo- or copolymer containing 0.0 to 5.0 wt.-% of a comonomer each based on the total weight of the metallocene-catalysed heterophasic polypropylene; and ii) 5 to 20 wt.-% based on the total weight of the metallocene-catalysed heterophasic polypropylene of an amorphous propylene ethylene elastomer optionally comprising C4-C12 alpha-olefin(s) as further comonomers, dispersed in said crystalline matrix i), wherein the crystalline matrix i) has a MFR2 (230° C., 2.16 kg, ISO 1133) in the range of 1.0 to 10.0 g/10 min and a melting point Tm (determined by DSC as described in the specification) in the range of 130 to 160° C.; and the amorphous phase ii) has a C2-content of the XCS fraction in the range of 10 to 50 wt.-% based on the total weight of the and an IV of the XCS fraction (DIN ISO 1628/1) in the range of 1.2 to 5.0 dl/g; and i) and ii) add up to 100 wt.-%, and b) 0.0001 to 1.0 wt.-% of a beta-nucleating agent; wherein components a) and b) add up to 100 wt.-%. The present invention further relates to a film made of this composition and its use.

The present invention relates to a polymer composition suitable for manufacturing a film comprising a specific metallocene-catalysed heterophasic polypropylene and a specific beta-nucleating agent. Furthermore, the present invention relates to films made of the inventive composition and their use.

Plastic packaging is widely used in daily life due to the good cost/performance ratio. Especially polyolefins are easy and economical to produce with good properties, therefore one can find them everywhere in life. Due to the different requirements nowadays multilayered articles with different type of materials are used, which from one side serve the needs, but have the disadvantage that recycling of these articles is difficult. From a recycling point of view, mono-material solutions would be preferred. At the same time the performance of the materials should not diminish. It remains challenging to provide polyolefin based polymer compositions which have excellent mechanical, such as a high toughness, which is normally provided by the core layer of a multilayered film, and at the same time excellent sealing properties, which are in general provided by an outer layer of a multilayered film.

Polymer compositions suitable for producing films are already known in the prior art.

EP 1 344 793 A1 refers to polyolefin compositions with high impact strength and high gloss, comprising A) a heterophasic propylene copolymer containing a) 50 to 95 wt.-% of a matrix phase comprising a propylene homopolymer or a propylene copolymer with up to 5 mol-% of ethylene and/or at least one C4-C8 alpha-olefin and b) 5 to 50 wt.-% of a disperse phase comprising an ethylene rubber copolymer with from 20 to 80 mol-% ethylene and from 80 to 20 mol-% of at least one C3-C8 alpha-olefin and where the intrinsic viscosity of the XCS-fraction of the heterophasic copolymer is ≤2 dl/g and B) a beta-nucleating agent and a process for their preparation and their use.

EP 2 055 739 A1 relates to a heterophasic propylene copolymer (HECO), wherein the heterophasic propylene copolymer (HECO) is β-nucleated and the elastomeric phase has an intrinsic viscosity measured in tetraline at 135° C. of equal or below 4.0 dl/g.

U.S. Pat. No. 5,310,584 A refers to a thermoformable sheet comprising a resinous polymer of propylene and an effective amount of a beta-spherulite nucleating agent, a process for making the sheet and articles thermoformed from the sheet.

US 2002/137851 A1 relates to polypropylene films and methods of making these films using high melt strength beta-crystalline polypropylene.

EP 1 803 772 A1 relates to a blown film made of a composition comprising a) a propylene heterophasic copolymer (A) with a matrix propylene polymer and an ethylene-propylene-rubber characterized in that the film has been monoaxially-oriented in the machine direction with a stretch ratio of 1:1.1 to 1:10, to a process for making such a film, to the use of said composition in making such a film, and to an article comprising such a film.

Starting therefrom, it is one objective of the present invention to provide a polymer composition for making films which does not only have excellent mechanical properties, especially high impact strength, but also allows to produce films with excellent sealing properties, such as improved Sealing Initiation Temperature and Hot Tack Force and superior mechanical properties.

This objective has been solved by the polymer composition according to claim 1 comprising the following components: a) 99.0 to 99.9999 wt.-% based on the total weight of the polymer composition of a metallocene-catalysed heterophasic polypropylene comprising: i) 80 to 95 wt.-% of a crystalline matrix being a propylene homo- or copolymer containing 0.0 to 5.0 wt.-% of a comonomer each based on the total weight of the metallocene-catalysed heterophasic polypropylene; and ii) 5 to 20 wt.-% based on the total weight of the metallocene-catalysed heterophasic polypropylene of an amorphous propylene ethylene elastomer optionally comprising C4-C12 alpha-olefin(s) as further comonomers, dispersed in said crystalline matrix i), wherein the crystalline matrix i) has a MFR₂ (230° C., 2.16 kg, ISO 1133) in the range of 1.0 to 10.0 g/10 min and a melting point Tₘ (determined by DSC as described in the specification) in the range of 130 to 160° C.; and the amorphous phase ii) has a C2-content of the XCS fraction in the range of 10 to 50 wt.-% based on the total weight of the XCS fraction and an IV of the XCS fraction (DIN ISO 1628/1) in the range of 1.2 to 5.0 dl/g; and i) and ii) add up to 100 wt.-%, and b) 0.0001 to 1.0 w.-t % of a beta-nucleating agent based on the total weight of the polymer composition; wherein components a) and b) add up to 100 wt.-%.

Advantageous embodiments of the polymer composition in accordance with the present invention are specified in the dependent claims 2 to 9. Furthermore, claims 10 to 14 relate to films comprising said polymer composition. The present invention further relates in accordance with claim 15 to the use of the article according to the present invention as packaging material.

### Definitions

### Indications of Quantity

The polymer composition in accordance with the present invention mandatorily comprises the components a) and b) and optionally additives c). The requirement applies here that the components a) and b) and if present the additives c) add up to 100 wt.-% in sum. The fixed ranges of the indications of quantity for the individual components a) and b) and optionally the additives c) are to be understood such that an arbitrary quantity for each of the individual components can be selected within the specified ranges provided that the strict provision is satisfied that the sum of all the components a), b) and optionally the additives c) add up to 100 wt.-%.

A metallocene-catalysed heterophasic polypropylene is defined in this invention as a heterophasic polypropylene, which has been produced in the presence of a metallocene catalyst. The catalyst influences in particular the microstructure of the polymer. Accordingly, polypropylenes prepared by using a metallocene catalyst provide a different microstructure compared to those prepared by using Ziegler-Natta (ZN) catalysts. The most significant difference is the presence of regio-defects in metallocene-made polypropylenes which is not the case for polypropylenes made by Ziegler-Natta (ZN) catalysts.

### Regio Defects

The region defects of propylene polymers can be of three different types, namely 2,1-erythro (2,le), 2,1-threo (2,lt) and 3,1 defects. A detailed description of the structure and mechanism of formation of regio defects in polypropylene can be found in Chemical Reviews 2000, 100 (4), pages 1316 to 1327. These defects are measured using ¹³C NMR as described in more detail below. The term “2,1 regio defects” as used in the present invention defines the sum of 2,1-erythro regio-defects and 2,1-threo regio defects. Propylene random copolymers or polypropylene homopolymers having a number of regio defects as required in the propylene composition of the invention are usually and preferably prepared in the presence of a single-site catalyst.

A homopolymer in the context of the present invention may comprise up to 3.0 mol-% based on the total weight of the homopolymer of comonomers, preferably up to 2.0 mol-% but may be also free of comonomers.

The beta-form or beta-modification in the gist of the present invention is a specific crystal modification of isotactic polypropylene formed during PP crystallization. It only exists with special conditions, e.g. with special nucleating agent—a beta-nucleating agent—or slow cooling rate, for example below 1° C. per minute.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### Polymer Composition

The polymer composition according to the present invention comprises 99.0 to 99.9999 wt.-% based on the total weight of the polymer composition of a metallocene-catalysed heterophasic polypropylene a).

Said component a) comprises i) 80 to 95 wt.-% of a crystalline matrix being a propylene homo- or copolymer containing 0.0 to 5.0 wt.-% of a comonomer each based on the total weight of the metallocene-catalysed heterophasic polypropylene; and ii) 5 to 20 wt.-% based on the total weight of the metallocene-catalysed heterophasic polypropylene of an amorphous propylene ethylene elastomer optionally comprising C4-C12 alpha-olefin(s) as further comonomers, dispersed in said crystalline matrix i), wherein the crystalline matrix i) has a MFR₂ (230° C., 2.16 kg, ISO 1133) in the range of 1.0 to 10.0 g/10 min and a melting point Tₘ (determined by DSC as described in the specification) in the range of 130 to 160° C.; and the amorphous phase ii) has a C2-content of the XCS fraction in the range of 10 to 50 wt.-% based on the total weight of the XCS fraction and an IV of the XCS fraction (DIN ISO 1628/1) in the range of 1.2 to 5.0 dl/g; and i) and ii) add up to 100 wt.-%.

Below preferred embodiments of the metallocene-catalysed heterophasic polypropylene a) are described.

In accordance with one preferred embodiment of the present invention component a) has a number of 2,1 and 3,1 regio defects in the range of 0.01 to 1.2 mol-%, preferably in the range of 0.1 to 1.0 mol-% and more preferably in the range of 0.3 to 0.9 mol-% as measured by ¹³C NMR.

According to one preferred embodiment the content of the crystalline matrix i) based on the total weight of component a) is in the range of 85 to 94 wt.-%, preferably 88 to 93 wt.-% and more preferably 90 to 92 wt.-% and the content of the amorphous polypropylene ethylene elastomer ii) based on the total weight of component a) is in the range of 6 to 15 wt.-%, preferably 7 to 12 wt.-% and more preferably 8 to 10 wt.-%. The content of the crystalline matrix i) and the amorphous polypropylene ethylene elastomer ii) may be determined by xylene cold soluble (XCS) fraction as determined according to ISO 16152.

Another preferred embodiment stipulates that the crystalline matrix i) is a homopolymer.

Still another preferred embodiment in accordance with the present invention stipulates that polymer a) has a xylene cold soluble (XCS) fraction as determined according to ISO 16152 of from 6 to 20 wt.-% and preferably from 8 to 13 wt.-% based on the weight of the metallocene-catalysed heterophasic polypropylene a).

According to another preferred embodiment according to the present invention the metallocene-catalysed heterophasic polypropylene a) has a MFR₂ (230° C., 2.16 kg, ISO 1133) in the range of 1 to 10 g/10 min, preferably in the range of 1.5 to 5 g/10 min and more preferably in the range of 1.5 to 3.0 g/10 min.

A further preferred embodiment of the present invention stipulates that the metallocene-catalysed heterophasic polypropylene a) has a C2-content based on the total weight of component a) in the range of 0.5 to 4 wt.-% and preferably 1.3 to 2.0 wt.-%.

Another preferred embodiment in accordance with the present invention stipulates that the metallocene-catalysed heterophasic polypropylene a) has a C2-content of the xylene cold soluble (XCS) fraction in the range of 10 to 40 wt.-% and preferably of 20 to 25 wt.-% based on the total weight of the xylene cold soluble (XCS) fraction.

In a further preferred embodiment in accordance with the present invention the metallocene-catalysed heterophasic polypropylene a) has an intrinsic viscosity of xylene cold soluble (XCS) fraction of 1.0 to 5.0 dl/g and preferably in the range of 2.0 to 2.7 dl/g.

It is further in accordance with the present invention that the metallocene-catalysed heterophasic polypropylene a) is mainly present in the polymer composition in its beta-nucleated form, preferably the content is 50 to 99 wt.-%, more preferably 75 to 88 wt.-% (determined by WAXS).

Another preferred embodiment of the present invention stipulates that the heterophasic polymer a) is produced in the presence of a metallocene catalyst, which is preferably a metallocene catalyst comprising a complex in any one of the embodiments as described in WO 2013/007650 A1, WO 2015/158790 A2 and WO 2018/122134 A1. In another preferred embodiment of the present invention a cocatalyst system comprising a boron containing cocatalyst, e.g. a borate cocatalyst and an aluminoxane cocatalyst is used.

A preferred embodiment according to the present invention stipulates that the metallocene-catalysed heterophasic polypropylene a) is produced in presence of a catalyst system comprising (i) a metallocene complex of the general formula (I)

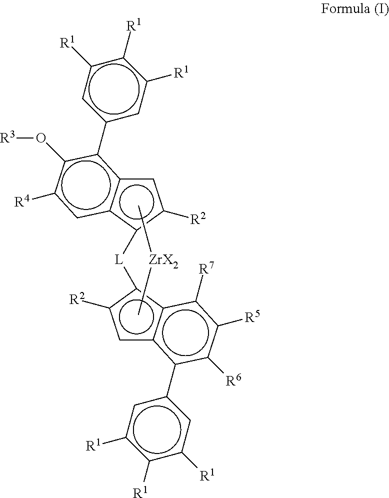

wherein each X independently is a sigma-donor ligand, L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C1-C20-hydrocarbyl group optionally containing one or more heteroatoms from groups 14-16 of the periodic table or fluorine atoms, or optionally two R′ groups taken together can form a ring, each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C1-10-hydrocarbyl group, and optionally two adjacent R¹ groups can be part of a ring including the phenyl carbons to which they are bonded, each R² independently are the same or can be different and are a CH₂-R⁸ group, with R⁸ being H or linear or branched C₁₋₆-alkyl group, C₃₋₈-cycloalkyl group, C₆₋₁₀-aryl group, R³ is a linear or branched C₁-C₆-alkyl group, C₇₋₂₀-arylalkyl, C₇₋₂₀-alkylaryl group or C₆-C₂₀-aryl group, R⁴ is a C(R⁹)₃ group, with R⁹ being a linear or branched C₁-C₆-alkyl group, R⁵ is hydrogen or an aliphatic C1-C₂₀-hydrocarbyl group optionally containing one or more heteroatoms from groups 14-16 of the periodic table; R⁶ is hydrogen or an aliphatic C1-C₂₀-hydrocarbyl group optionally containing one or more heteroatoms from groups 14-16 of the periodic table; or R⁵ and R⁶ can be taken together to form a 5 membered saturated carbon ring which is optionally substituted by n groups R¹⁰, n being from 0 to 4; each R¹⁰ is same or different and may be a C1-C₂₀-hydrocarbyl group, or a C1-C₂₀-hydrocarbyl group optionally containing one or more heteroatoms belonging to groups 14-16 of the periodic table; R⁷ is H or a linear or branched C₁-C₆-alkyl group or an aryl or heteroaryl group having 6 to 20 carbon atoms optionally substituted by one to three groups R¹¹, each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group,
(ii) a co-catalyst system comprising a boron containing co-catalyst and/or an aluminoxane co-catalyst, and
(iii) a silica support.

According to still another preferred embodiment in accordance with the present invention the metallocene complex is selected from the group consisting of rac-dimethylsilanediylbis [2-methyl-4-(3′,5′-dimethylphenyl)-5-methoxy-6-tert-butylinden-1-yl] zirconium dichloride, rac-anti-dimethylsilanediyl [2-methyl-4-(4′-tert-butylphenyl)-inden-1-yl][2-methyl-4-(4′-tertbutylphenyl)-5-methoxy-6-tert-butylinden-1-yl] zirconium dichloride, rac-anti-dimethylsilanediyl [2-methyl-4-(4′-tert-butylphenyl)-inden-1-yl][2-methyl-4-phenyl-5-methoxy-6-tert-butylinden-1-yl] zirconium dichloride, rac-anti-dimethylsilanediyl [2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride, rac-anti-dimethylsilanediyl [2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride, rac-anti-dimethylsilanediyl [2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl] zirconium dichloride, and rac-anti-dimethylsilanediyl [2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl] zirconium dichloride.

The polymer composition according to the present invention also comprises 0.0001 to 1.0 wt.-% based on the total weight of the polymer composition of a beta-nucleating agent b).

Below preferred embodiments of the beta-nucleating agent b) are described.

According to one preferred embodiment of the present invention the beta-nucleating agent b) is selected from the group consisting of N,N′-dicyclohexyl-2,6-naphthalenedicarboxamide, Quino [2,3-b] acridine-6,7,13,14(5H, 12H)-tetrone, organometallic salt-type beta-nucleating agents and mixtures thereof, and preferably is an organometallic salt-type beta-nucleating agent, more preferably the polymer composition is free of alpha-nucleating agents.

Suitable organometallic salt-type beta-nucleating agents are for example commercially available from GCH (CN) under the tradename NAB-82. N,N′-dicyclohexyl-2,6-naphthalenedicarboxamide is for example available from New Japan Chemical under the tradename NJ Star Nu-100. Quino [2,3-b] acridine-6,7,13,14(5H, 12H)-tetrone is commercially available from BASF.

Another preferred embodiment of the present stipulates that the polymer composition has a MFR₂ (230° C., 2.16 kg, ISO 1133) in the range of 1.0 to 10.0 g/10 min, preferably in the range of 1.5 to 5.0 g/10 min and more preferably in the range of 2.0 to 4.0 g/10 min.

In still a further prefer embodiment of the present invention the polymer composition has a melting point Tₘ₁ in the range of 140 to 160° C., preferably of 155 to 160° C. and a melting point Tₘ₂ in the range of 120 to 160° C., preferably of 140 to 150° C. (both determined by DSC as described in the specification), whereby Tₘ₁>Tₘ₂ and the crystallisation temperature T_{c} is >114° C., preferably in the range of >114 to 125° C.

According to another preferred embodiment in accordance with the present invention a 50 μm blown film (produced as described in the specification) of the polymer composition has a K_{B} (determined by wide angle X-ray scattering as described in the specification) of >0.60, preferably >0.70, even more preferably >0.80, still more preferably from 0.80 to 0.99 and most preferably from 0.85 to 0.98.

A further preferred embodiment in accordance with the present invention stipulates that the polymer composition has a Notched Impact Strength NIS (determined according to ISO179/1 eA at ±23° C.) of >45 kJ/m², preferably in the range of 50.0 to 90.0 kJ/m², more preferably in the range of 60.0 to 80.0 kJ/m².

A further preferred embodiment in accordance with the present invention stipulates that the polymer composition has a Flexural Modulus (determined according to ISO 178) of >800 MPa, preferably in the range of 900 to 1500 MPa, more preferably in the range of 1000 to 1200 MPa.

Still another preferred embodiment in accordance with the present invention stipulates that the polymer composition has a xylene cold soluble (XCS) fraction as determined according to ISO 16152 from 6 to 20 wt.-% and preferably from 8 to 13 wt.-% based on the weight of the metallocene-catalysed heterophasic polypropylene a).

According to another preferred embodiment according to the present invention the polymer composition comprises 99.5 to 99.95 wt.-% and preferably 99.6 to 99.8 wt.-% based on the total weight of the polymer composition of the metallocene-catalysed heterophasic polypropylene a); and 0.05 to 0.2 wt.-% and preferably 0.075 to 0.125 wt.-% based on the total weight of the polymer composition of the nucleating agent b); whereby the polymer composition additionally contains additives c) different from b) and components a), b) and c) add up to 100 wt.-%.

In a further preferred embodiment of the present invention the additives c) are selected from the group consisting of antioxidants, hydroltalcite, preferably synthetic hydrotalcites, slip agents, antiblock agents, UV stabilisers and mixtures thereof. It is furthermore preferred that additives which act as alpha-nucleating agents are not present in the polymer composition according to the present invention.

### Film

Another aspect of the present invention relates to a film, preferably a blown film, comprising at least one layer comprising at least 90 wt.-%, preferably at least 95 wt.-% and more preferably at least 99 wt.-% of the polymer composition according to the present invention. The film may also consist of said polymer composition.

According to one preferred embodiment in accordance with the present invention the film comprises a sealing layer comprising the polymer composition according to the present invention.

In a further embodiment of the present invention the film has a Dart Drop Strength (ISO 7765-1) of >150 g, preferably in the range of 300 to 1000 g and more preferably in the range of 350 to 600 g.

Still another preferred embodiment of the present invention stipulates that the film has a Sealing Initiation Temperature (determined as described in the specification) in the range of 120 to 135° C. and preferably in the range of 129 to 131° C.

According to a further preferred embodiment in accordance with the present invention the film has a Hot Tack Force (determined as described in the specification) in the range of 5.1 to 7.0 N and preferably in the range of 5.3 to 6.0 N.

In a further embodiment of the present invention the film has a Hot Tack Temperature in the range of 125 to 136° C. and preferably in the range of 128 to 133° C.

Still another preferred embodiment of the present invention stipulates that the film has a Tensile Modules (in machine direction and transversal direction) above 1000 MPa, preferably in the range of 1050 to 1500 MPa and more preferably in the range of 1080 to 1250 MPa.

According to a further preferred embodiment in accordance with the present invention the film has a crystallinity index X_{c} in the range of 55 to 80% and preferably 60 to 66%.

In a further embodiment of the present invention the film has an amount of β-form of the polypropylene within the crystalline phase K_{β} in the range of 0.6 to 0.99 and preferably 0.95 to 0.98.

The film in accordance with the present invention preferably has a thickness in the range of 20 to 200 μm, preferably 30 to 100 μm and more preferably 40 to 60 μm.

Generally, the film according to the present invention can be produced by a blown film or cast film process, preferably by a blown film process.

In order to manufacture such films, for example at least three polymer melt streams are simultaneously extruded (i.e. coextruded) through a multi-channel tubular, annular or circular die to form a tube which is blown-up, inflated and/or cooled with air (or a combination of gases) to form a film. The manufacture of blown film is a well-known process.

The blown (co-)extrusion can be effected at a temperature in the range 150 to 230° C., more preferably 160 to 225° C. and cooled by blowing gas (generally air) at a temperature of 10 to 40° C., more preferably 12 to 16° C. to provide a frost line height of 0.5 to 4 times, more preferably 1 to 2 times the diameter of the die.

The blow up ratio (BUR) should generally be in the range of 1.5 to 3.5, preferably 2.0 to 3.0, more preferably 2.1 to 2.8.

All preferred aspects and embodiments as described above for the polymer composition shall also hold for the film according to the present invention.

### Use

Another aspect of the present invention relates to the use of the film according to any of the preceding claims as packing material, preferably for food and/or medical products.

The invention will now be described with reference to the following non-limiting examples.

### EXPERIMENTAL PART

### A. Measuring Methods

The following definitions of terms and determination methods apply for the above general description of the invention as well as to the below examples unless otherwise defined.

### Melt Flow Rate

The melt flow rate (MFR) was determined according to ISO 1133—Determination of the melt mass-flow rate (MFR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR of polypropylene is determined at a temperature of 230° C. and at loadings of 2.16 kg (MFR₂.

DSC Analysis, Melting (Tₘ) and Crystallization Temperature (T_{c}) and Beta-Content

Data was measured with a TA Instrument Q2000 differential scanning calorimetry (DSC) on 5 to 7 mg samples. DSC was run according to ISO 11357/part 3/method C2 in a heat/cool/heat cycle with a scan rate of 10° C./min in the temperature range of −30 to +225° C. Crystallization temperature (T_{c}) and crystallization enthalpy (H_{c}) were determined from the cooling step, while melting temperature (Tₘ) and melting enthalpy (Hₘ) are determined from the second heating step. The beta content of the materials can be determined as following: Beta content

$$( DSC ) ⋆ = 100 \times \frac{Hm 2}{Hm 1 + Hm 2} ,$$

where Hₘ₂ is the melting enthalpy of beta-form and Hₘ₁ is the melting enthalpy of alpha form, both are measured from second heating step. As mentioned the melting points Tₘ₁ and Tₘ₂ are determined during the second heating step, whereas Tₘ₁ is only observed for the alpha-form of the polymer, whereas Tₘ₂ is observed for the beta-form.

### Dart Drop Strength (DDI): Impact Resistance by Free-Falling Dart Method

The DDI was measured according to ISO 7765-1:1988/Method A from the films as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Results:

Impact failure weight −50% [g].

### Notched Impact Strength (NIS)

The Charpy notched impact strength (NIS) was measured according to ISO 179 1 eA at −20° C., 0° C. and +23° C., using injection molded bar test specimens of 80×10×4 mm³ prepared in accordance with ISO 19069-2.

### Flexural Modulus

The flexural modulus was determined in 3-point-bending at 23° C. according to ISO 178 on 80×10×4 mm³ test bars injection molded in line with ISO 19069-2.

### Intrinsic Viscosity

The intrinsic viscosity (IV) is measured in analogy to DIN ISO 1628/1, October 1999, in Decalin at 135° C.

### Xylene Cold Soluble Fraction (XCS)

“Xylene Cold Soluble” (XCS) fraction and “Xylene Cold Insoluble” (XCI) fraction, respectively, is determined according to standard gravimetric method as per ISO 16152.

### Sealing Initiation Temperature (SIT); Sealing End Temperature (SET), Sealing Range

The method determines the sealing temperature range (sealing range) of polypropylene films, in particular blown films or cast films, produced as below. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, cooling time and test speed have been modified. The determination of the force/temperature curve was continued until thermal failure of the film.

The sealing range was determined on a J&B Universal Sealing Machine Type 4000 with a blown film of 50 μm thickness with the following further parameters:
Conditioning time: >96 h
Specimen width: 25 mm
Sealing pressure: 0.67 N/mm² (PP)
Sealing time: 1 sec
Delay time: 30 sec
Sealing jaws dimension: 50×5 mm
Sealing jaws shape: flat
Sealing jaws coating: Niptef
Sealing temperature: ambient −240° C.
Sealing temperature interval: 5° C.
Start temperature: 50° C.
Grip separation rate: 42 mm/sec.

### Hot Tack Temperature (HTT) and Hot Tack Force (HTF)

HTT (lowest temperature to get maximum Hot Tack Force) and HTF (maximum Hot Tack Force) were measured according to ASTM F 1921 method B on film of 50 μm thickness with below settings:
Q-name instrument: Hot Tack-Sealing Tester
Model: J&B model 4000 MB
Sealbar length: 50 [mm]
Seal bar width: 5 [mm]
Seal bar shape: flat
Seal Pressure: 0.15 N/mm²
Seal Time: 1 s
Coating of sealing bars: NIPTEF®
Roughness of coating sealing bars 1 [μm]
Film Specimen width: 25 mm
Cool time: 0.2 s
Peel Speed: 200 mm/s
Start temperature: 50° C.
End temperature: burn through and/or shrinking
Increments: 5° C.

All film test specimens were prepared in standard atmospheres for conditioning and testing at 23° C. (±2° C.) and 50% (±10%) relative humidity. The minimum conditioning time of test specimen in standard atmosphere just before start testing is at least 40 hours. The minimum storage time between extrusion of film sample and start testing is at least 88 hours. The hot-tack measurement determines the strength of heat seals formed in the films, immediately after the seal has been made and before it cools to ambient temperature.

HTF was measured as a function of temperature within the temperature range and with temperature increments as indicated above. The number of test specimens were at least 3 specimens per temperature. HTF is evaluated as the highest force (maximum peak value) with failure mode “peel”.

### ¹³C NMR Spectroscopy-Based Determination of C2 Content for the Calibration Standards

Quantitative ¹³C{¹H} NMR spectra were recorded in the solution-state using a Bruker Avance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium (III) acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225, Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra. Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present.

Characteristic signals corresponding to the incorporation of ethylene were observed (Cheng, H. N., Macromolecules 17 (1984), 1950) and the comonomer fraction calculated as the fraction of ethylene in the polymer with respect to all monomer in the polymer:

$$fE = ( E / ( P + E ) )$$

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents. For systems with very low ethylene content where only isolated ethylene in PPEPP sequences were observed the method of Wang et. al. was modified reducing the influence of integration of sites that are no longer present. This approach reduced the overestimation of ethylene content for such systems and was achieved by reduction of the number of sites used to determine the absolute ethylene content to

$$E = 0.5 ( S ββ + S βγ + S βδ + 0.5 ( S αβ + S αγ ) )$$

Through the use of this set of sites the corresponding integral equation becomes

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified. The mole percent comonomer incorporation was calculated from the mole fraction:

$$E [ mol \% ] = 0 ⋆ fE .$$

The weight percent comonomer incorporation was calculated from the mole fraction:

$$E [ wt \% ] = 100 ⋆ ( fE ⋆ 28.06 ) / ( ( fE ⋆ 28.06 ) + ( ( 1 - fE ) ⋆ 42. 08 ) ) .$$

### Quantification of Microstructure by NMR Spectroscopy (Comonomer Content & Regiodefects)

Quantitative nuclear-magnetic resonance (NMR) spectroscopy was further used to quantify the comonomer content and comonomer sequence distribution of the polymers. Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimized 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra. Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

### Wide Angle X-Ray Scattering Measurement (WAXS)

The measurement of wide-angle X-ray scattering (WAXS) of the samples was conducted by a Bruker D8 Discover apparatus. The diffractometer was equipped with an X-ray tube with a copper target operating at 30 kV and 20 mA and a GADDS 2-D detector. A point collimation (0.5 mm) was used to direct the beam onto the surface. The measurement was done in reflection geometry, and 28 angle in the range from 10° to 32.5° were measured. Data were collected for 300 s. Intensity vs. 2-theta curve was acquired with the same measurement parameters on an amorphous polypropylene sample, which was prepared by solvent extraction. An amorphous halo was obtained by smoothing the curve. The amorphous halo has been subtracted from the measured intensity vs. 2-theta curve to result in the crystalline curve.

The crystallinity index X_{c} can be defined with the area under the crystalline curve and the original spectrum using Challa, Hermans and Weidinger method [Challa G, Hermans P H, Weidinger A, Makromol. Chem. 56, 169 (1962)] as:

$${X}_{c} = \frac{area under crystalline curve}{area under original spectrum} \times 100$$

The amount of β-form of the polypropylene within the crystalline phase K_{β} is calculated using Jones method [Turner-Jones A, Aizlewood J M, Beckett D R, Makromol. Chem. 75, 134 (1974)] according to the following equation

$${K}_{β} = \frac{{I}^{β} ( 300 )}{{I}^{α} ( 110 ) + {I}^{α} ( 040 ) + {I}^{α} ( 130 ) + {I}^{β} ( 300 )}$$

where, Iβ(300) is the intensity of β(300) peak, Iα(110) is the intensity of α(110) peak, Iα(040) is the intensity of α(040) peak and Iα(130) is the intensity of α(130) peak obtained after subtracting the amorphous halo.

The amount of γ-form of isotactic polypropylene (iPP) within the crystalline phase K_{γ} is calculated using the method developed by Pae [Pae K D, J. Polym. Sci., Part A, 6, 657 (1968)] as:

$${K}_{γ} = \frac{{I}^{γ} ( 117 )}{{I}^{α} ( 130 ) + {I}^{γ} ( 117 )}$$

where Iα(130) is the intensity of α(130) peak and Iγ(117) is the intensity of γ(117) peak obtained after subtracting a base line joining the base of these peaks.

Quantification of three-phase crystalline system has been carried out following the procedure explained in Obadal M, Cermak R, Stoklasa K, Macromol. Rapid Commun. 26, 1253 (2005).

For three-phase crystalline systems the following equations have been used to determine K_{α} (amount of α-phase), K_{β} (amount of β-phase) and K_{γ} (amount of γ-phase):

$${K}_{β} = \frac{{I}^{β} ( 300 )}{{I}^{α} ( 110 ) + {I}^{α} ( 040 ) + {I}^{α} ( 130 ) + {I}^{β} ( 300 ) + {I}^{γ} ( 117 )}$$

$${K}_{α + γ} = 1 - {K}_{β} ,$$

$${K}_{γ} = G \times {K}_{α + γ} ,$$

$$and$$

$${K}_{α} = 1 - {K}_{β} - {K}_{γ}$$

### Tensile Modulus (TM)

Tensile modulus (MPa) was measured in machine (MD) and transverse direction (TD) according to ISO 527-3 on film samples (prepared as described below and at a cross head speed of 1 mm/min.

### B. Materials Used

AO is an antioxidant commercially available as Irganox B 215 (FF) from BASF SE (CH).

SHT is synthetic hydrotalcite commercially available as DHT-4V from Kisuma Chemicals (NL).

NU is an organometallic salt-type beta-nucleating agent commercially available as NAB-82 from GCH (CN).

HECO is a SSC-based C2C3-heterophasic copolymer and was prepared as follows.

### Catalyst Preparation (CAT)

### Catalyst Synthesis

The metallocene (MC) used was Anti-dimethylsilanediyl [2-methyl-4,8-di(3,5-dimethylphenyl)-1,5,6,7-tetrahydro-s-indacen-1-yl][2-methyl-4-(3,5-dimethylphenyl)-5-methoxy-6-tert-butylinden-1-yl] zirconium dichloride as disclosed in EP19177308.4 as ICS3.

### Preparation of MAO-Silica Support

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (5.0 kg) was added from a feeding drum followed by careful pressuring and depressurising with nitrogen using manual valves. Then toluene (22 kg) was added. The mixture was stirred for 15 minutes and next 30 wt.-% solution of MAO in toluene (9.0 kg) from Lanxess was added via feed line on the top of the reactor within 70 minutes. The reaction mixture was then heated up to 90° C. and stirred at that temperature for additional two hours. Then the slurry was allowed to settle and the mother liquor was filtered off. The catalyst was washed twice with toluene (22 kg) at 90° C., following by settling and filtration. The reactor was cooled off to 60° C. and the solid was washed with heptane (22.2 kg). Finally MAO treated SiO₂ was dried at 60° C. under nitrogen flow for 2 hours and then for 5 hours under vacuum (−0.5 barg) with stirring. MAO treated support was collected as a free-flowing white powder found to contain 12.2 wt.-% Al.

### Catalyst Preparation

30 wt.-% MAO in toluene (0.7 kg) was added into a steel nitrogen blanked reactor via a burette at 20° C. Toluene (5.4 kg) was then added under stirring. The MC as cited above (93 g) was added from a metal cylinder followed by flushing with 1 kg toluene. The mixture was stirred for 60 minutes at 20° C. Trityl tetrakis(pentafluorophenyl) borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under nitrogen flow at 60° C. for 2 hours and additionally for 5 hours under vacuum (−0.5 barg) under stirring. The dried catalyst was sampled in the form of pink free flowing powder containing 13.9 wt.-% Al and 0.11 wt.-% % Zr.

### Polymerization:

The polymerization was carried out in a Borstar pilot plant with a 3-reactor set-up (loop—GPR-GPR2) and a prepolymerization loop reactor according to the conditions as given in Table 1.

TABLE 1
Polymerization conditions.

| | HECO |
|---|---|
| Prepoly reactor | |
| Catalyst | CAT |
| Temperature (° C.) | 20 |
| Pressure (kPa) | 5347 |
| H2/C3 ratio (mol/kmol) | 0.07 |
| Residence time (h) | 0.35 |
| Loop reactor (crystalline matrix i) | |
| Temperature (° C.) | 75 |
| Pressure (kPa) | 5322 |
| H2/C3 ratio (mol/kmol) | 0.15 |
| Split (wt.-%) | 60 |
| Residence time (h) | 0.4 |
| MFR₂ (g/10 min) | 1.2 |
| Gas phase reactor 1 (crystalline matrix i) | |
| Temperature (° C.) | 80 |
| Pressure (kPa) | 2100 |
| H2/C3 ratio (mol/kmol) | 0.99 |
| Split (wt.-%) | 31 |
| Residence time (h) | 1.6 |
| MFR₂ (g/10 min) | 2.1 |
| MFR₂ (g/10 min) made in GPR1 (calculated) | 6.0 |
| Gas phase reactor 2 (amorphous phase ii) | |
| Temperature (° C.) | 70 |
| Pressure (kPa) | 2030 |
| H2/C2 ratio (mol/kmol) | 2.05 |
| C2/C3 ratio (mol/kmol) | 852 |
| Split (wt.-%) | 9 |
| Residence time (h) | 2.1 |

Table 2 summarizes some properties of HECO.

TABLE 2
Properties of HECO.

| | | |
|---|---|---|
| Properties | Unit | HECO |

Total polymer powder

| | | |
|---|---|---|
| XCS | wt.-% | 8.8 |
| C2-content | % | 1.7 |
| C2/XCS | wt.-% | 22.9 |
| IV/XCS | dl/g | 2.3 |

The polymer powder was mixed under nitrogen atmosphere with the further ingredients shown in Table 3 below. Then it was compounded and extruded under nitrogen atmosphere to pellets by using a ZSK 18 twin screw extruder (Tₘ=210° C., production rate of 7 kg/h).

### C. Manufacturing of Blown Films

Blown films were produced on a Collin lab scale blown film line having the composition shown in Table 3 with a total thickness of 50 μm (melt temperature: 210° C., BUR 1:2.5, uptake speed: 7 m/min).

### D. Results

TABLE 3
Composition and properties of polymer
composition and blown films.

| Polymer composition | Unit | CE1 | IE1 |
|---|---|---|---|
| HECO | wt.-% | 99.8 | 99.7 |
| AO | wt.-% | 0.15 | 0.15 |
| SHT | wt.-% | 0.05 | 0.05 |
| NU | wt.-% | — | 0.1 |

Properties composition

| | | | |
|---|---|---|---|
| MFR | g/10 min | 3 | 3 |
| XCS | wt.-% | 9.13 | n.m. |
| IV(XCS) | dl/g | 2.35 | n.m. |
| C2(XCS) | wt.-% | 24.6 | n.m. |
| Tc | ° C. | 119 | 121 |
| Tₘ₁ | ° C. | 157 | 157 |
| Tₘ₂ | ° C. | n.d. | 145 |
| H_{M1} | J/g | 93 | 15.6 |
| Hₘ₂ | J/g | n.d. | 76.4 |
| Beta-content (DSC) | % | 0.0 | 83.0 |
| Flex Modulus | MPa | 1185 | 1037 |
| NIS | kJ/m² | 8.8 | 68.6 |

Properties blown film (50 μm)

| | | | |
|---|---|---|---|
| DDI | G | 74 | 404 |
| SIT | ° C. | 136 | 131 |
| HTF | N | 5.1 | 5.5 |
| HTT | ° C. | 137 | 131 |
| TM/MD | MPa | 1287 | 1106 |
| TM/TD | MPa | 1231 | 1189 |
| X_{c} | % | 63.9 | 63.8 |
| K_{β} | — | 0.03 | 0.96 |

n.m. = not measured;
n.d. = not detected;
HECO has a total number of 2, 1 and 3, 1 regio defects of 0.6 mol-%.

### E. Discussion of the Results

The polymer composition according to the comparative example (CE1) contains the same base polymer and the same stabilisation package as the polymer composition according to the inventive example (IE1), but does not contain a beta-nucleating agent. As can be gathered from above Table 3 the polymer composition according to the invention contains 83.0% of the beta-modification measured by DSC. Furthermore, it can be seen from said table that the stiffness, expressed by the Flexural Modulus, of the inventive polymer composition is only slightly worse, whereas a major increase of the impact strength, expressed by the Notch Impact Strength (NIS), can be observed. Furthermore, both of IE and CE were converted to a blown film, the IE has sufficient high amount of beta-form (measured by WAXS as kβ), while the CE has negligible amount of polypropylene in the beta-form. As consequence, a blown film prepared from the inventive polymer composition shows not only improved sealing properties, expressed by a lower Sealing Initiation Temperature and higher Hot Tack Force, but also better mechanical properties, expressed by the Dart Impact strength with very little penalty of the stiffness.

1. A polymer composition suitable for manufacturing a film comprising the following components:
a) 99.0 to 99.9999 wt. % based on the total weight of the polymer composition of a metallocene-catalysed heterophasic polypropylene comprising:
i) 80 to 95 wt. % of a crystalline matrix being a propylene homo- or copolymer containing 0.0 to 5.0 wt. % of a comonomer each based on the total weight of the metallocene-catalysed heterophasic polypropylene; and
ii) 5 to 20 wt. % based on the total weight of the metallocene-catalysed heterophasic polypropylene of an amorphous propylene ethylene elastomer optionally comprising C4-C₁₂ alpha-olefin(s) as further comonomers, dispersed in said crystalline matrix i), wherein
the crystalline matrix i) has a MFR2 (230° C., 2.16 kg, ISO 1133) in the range of 1.0 to 10.0 g/10 min and a melting point Tm (determined by DSC as described in the specification) in the range of 130 to 160° C.; and
the amorphous phase ii) has a C2-content of the XCS fraction in the range of 10 to 50 wt. % based on the total weight of the XCS fraction and an IV of the XCS fraction (DIN ISO 1628/1) in the range of 1.2 to 5.0 dl/g; and
i) and ii) add up to 100 wt. %, and
b) 0.0001 to 1.0 wt. % of a beta-nucleating agent; wherein components a) and b) add up to 100 wt. %.

2. The polymer composition according to claim 1, wherein,
the polymer composition has a MFR2 (230° C., 2.16 kg, ISO 1133) in the range of 1 to 10 g/10 min, and;
component a) has a total number of 2,1 and 3,1 regio defects in the range of 0.01 to 1.2 mol % as measured by ¹³C NMR.

3. The polymer composition according to claim 1, wherein,
the polymer composition has a melting point Tm1 in the range of 140 to 160° C. and a melting point Tm2 in the range of 120 to 160° C. (both determined by DSC as described in the specification), whereby Tm1>Tm2 and the crystallisation temperature Tc is >114° C. (determined by DSC as described in the specification).

4. The polymer composition according to claim 1, wherein,
a 50 μm blown film (produced as described in the specification) of the polymer composition has a Kß (determined by wide angle X-ray scattering as described in the specification) of >0.60.

5. The polymer composition according to claim 1, wherein,
the polymer composition has a Notched Impact Strength NIS (determined according to ISO179/1 eA at +23° C.) of >45 kJ/m².

6. The polymer composition according to claim 1, wherein,
the metallocene-catalysed heterophasic polypropylene a) is produced in presence of a catalyst system comprising:
(i) a metallocene complex of the general formula (I): 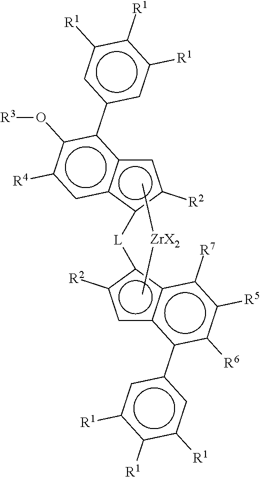
wherein each X independently is a sigma-donor ligand,
L is a divalent bridge selected from —R′2C-, —R′2C-CR′2-, —R′2Si—, —R′2Si—SiR′2-, —R′2Ge—, wherein each R′ is independently a hydrogen atom or a C1-C20-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C1-C6-alkyl group, a C7-20-arylalkyl, C7-20-alkylaryl group or C6-20-aryl group or an OY group, wherein Y is a C1-10-hydrocarbyl group, and optionally two adjacent R1 groups can be part of a ring including the phenyl carbons to which they are bonded,
each R² independently are the same or can be different and are a CH2-R8 group, with R8 being H or linear or branched C1-6-alkyl group, C3-8-cycloalkyl group, C6-10-aryl group,
R³ is a linear or branched C1-C6-alkyl group, C7-20-arylalkyl, C7-20-alkylaryl group or C6-C₂₀-aryl group,
R⁴ is a C(R9)3 group, with R9 being a linear or branched C1-C6-alkyl group,
R⁵ is hydrogen or an aliphatic C1-C20-hydrocarbyl group optionally containing one or more heteroatoms from groups 14-16 of the periodic table;
R⁶ is hydrogen or an aliphatic C1-C20-hydrocarbyl group optionally containing one or more heteroatoms from groups 14-16 of the periodic table; or
R⁵ and R⁶ can be taken together to form a 5 membered saturated carbon ring which is optionally substituted by n groups R10, n being from 0 to 4;
each R¹⁰ is same or different and may be a C1-C20-hydrocarbyl group, or a C1-C20-hydrocarbyl group optionally containing one or more heteroatoms belonging to groups 14-16 of the periodic table;
R⁷ is H or a linear or branched C1-C6-alkyl group or an aryl or heteroaryl group having 6 to 20 carbon atoms optionally substituted by one to three groups R11,
each R11 are independently the same or can be different and are hydrogen, a linear or branched C1-C6-alkyl group, a C7-20-arylalkyl, C7-20-alkylaryl group or C6-20-aryl group or an OY group, wherein Y is a C1-10-hydrocarbyl group,
(ii) a co-catalyst system comprising a boron containing co-catalyst and/or an aluminoxane co-catalyst, and
(iii) a silica support.

7. The polymer composition according to claim 6, wherein,
the metallocene complex is selected from the group consisting of rac-dimethylsilanediylbis [2-methyl-4-(3′,5′-dimethylphenyl)-5-methoxy-6-tert-butylinden-1-yl] zirconium dichloride,
rac-anti-dimethylsilanediyl [2-methyl-4-(4′-tert-butylphenyl)-inden-1-yl][2-methyl-4-(4′-tertbutylphenyl)-5-methoxy-6-tert-butylinden-1-yl] zirconium dichloride,
rac-anti-dimethylsilanediyl [2-methyl-4-(4′-tert-butylphenyl)-inden-1-yl][2-methyl-4-phenyl-5-methoxy-6-tert-butylinden-1-yl] zirconium dichloride,
rac-anti-dimethylsilanediyl [2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl [2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl [2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl] zirconium dichloride, and
rac-anti-dimethylsilanediyl [2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl] zirconium dichloride.

8. The polymer composition according to claim 1, wherein,
the beta-nucleating agent b) is selected from the group consisting of N,N′-dicyclohexyl-2,6-naphthalenedicarboxamide, Quino [2,3-b] acridine-6,7,13,14(5H,12H)-tetrone, organometallic salt-type beta-nucleating agent and mixtures thereof.

9. The polymer composition according to claim 1, wherein,
the polymer composition comprises:
99.5 to 99.95 wt. % based on the total weight of the polymer composition of the metallocene-catalysed heterophasic polypropylene a); and
0.05 to 0.2 wt. % based on the total weight of the polymer composition of the nucleating agent b); whereby the polymer composition additionally contains additives c) different from b) and components a), b) and c) add up to 100 wt.

10. A film comprising at least one layer comprising at least 90 wt. % of the polymer composition according to claim 1.

11. The film according to claim 10, wherein,
the film comprises a sealing layer comprising the polymer composition.

12. The film according to claim 10, wherein:
the film has a Dart Drop Strength (ISO 7765-1) of >150 g.

13. The film according to claim 1, wherein:
the film has a Sealing Initiation Temperature (determined as described in the specification) in the range of 120 to 135° C.

14. The film according to claim 10, wherein:
the film has a Hot Tack Force (determined as described in the specification) in the range of 5.1 to 7.0 N.

15. (canceled)
